(19) United States
(12) Patent Application Publication
(10) Pub. No.: US 2010/0045538 A1
(43) Pub. Date: Feb. 25, 2010

(54) RF TRANSPARENT HOUSING HAVING A METALLIC APPEARANCE

(75) Inventors: Peter Charles East, Mesa, AZ (US); Dirk Jordan, Gilbert, AZ (US)

Correspondence Address: INGRASSIA FISHER & LORENZ, P.C. (MOT), 7010 E. Cochise Road, SCOTTSDALE, AZ, 85253, US

(73) Assignee: Motorola, Inc., Schaumburg, IL (US)

(21) Appl. No.: 12/193,977

(22) Filed: Aug. 19, 2008

(51) Int. Cl. H01Q 1/42; H01B 1/00; B32B 5/00; H01Q 1/24

(52) U.S. Cl. 343/702; 252/500; 428/336; 343/872

(57) ABSTRACT

An apparatus and method for forming an electronic device (110) including an antenna (212) coupled to circuitry (216, 218) for conducting signals in the radio frequency range and a housing (120, 300, 400, 600, 700) encasing the circuitry (216, 218) and the antenna (212). The housing (120, 300, 400, 600, 700) includes a coating material (314, 604, 704) overlying a substrate (312, 602, 702), the coating material (314, 604, 704) being substantially non-conducting and including a metal having a ten percent atomic weight of the combined non-conducting material and the metal. The housing (120, 300, 400, 600, 700) minimally attenuates signals in the radio frequency range and provides a metallic appearance to reflected light in the visible range.

### FIELD

The present invention generally relates to portable electronic devices and more particularly to a method and apparatus for providing a desirable appearance for the housing thereof.

### BACKGROUND

The market for electronic devices, especially personal portable electronic devices, for example, cell phones, personal digital assistants (PDA's), digital cameras, and music playback devices (MP3), is very competitive. Manufactures are constantly improving their product with each model in an attempt to cut costs and to meet production requirements.

The look and feel of personal portable electronics devices is now a key product differentiator and one of the most significant reasons that consumers choose specific models. Consumers are enamored with appearance features that reflect personal style. Consumers select them for some of the same reasons that they select clothing styles, clothing colors, and fashion accessories. From a business standpoint, outstanding designs (form and appearance) may increase market share and margin.

Many portable electronic devices have been made with metallic looking surfaces, which have great appeal to consumers. The Motorola RAZR cell phone, for example, has a magnesium housing. However, it is very difficult to provide a uniform metallic look over the entire phone surface. In a commercially available example, a thin semi-transparent gold coating is deposited on the protective transparent material overlying the LCD display. The surface looks gold until the LCD backlight is activated. Then a fraction of the LCD light penetrates the semitransparent coating to reveal the display. This scheme is inefficient with power, but more importantly, since the reflective surface is still present, the contrast of the emissive display is poor under bright lighting conditions encountered outdoors.

The other trend is the use of very high gloss materials for the housing with a focus on the aesthetic appeal of the device, which suffers a similar aesthetic and functional degradation due to scratches, scuffing, abrasions and the like. This is particularly true for products which receive significant handling, such as persona data assistants (PDAs) and cell phones. This has led to the result that any type of scratches, scuffing, or abrasions is especially undesirable as it tends to be very noticeable and can degrade both the functional and aesthetic performance of the device. This degradation may also lead to breakage of the display cover.

Many materials have been mentioned for use as hard coatings. A single layer ceramic coating including Al₂O₃, ZrO₂, and DLC (amorphous diamond like carbon) is most common. Al₂O₃, commercially available as coatings of, for example, cutting tools, is hard and chemically inert, and is excellent as an anti-oxidation coating for high temperatures. It has a smooth surface with minimum friction and very low optical absorption in the visible range extending to ultraviolet. Corundum, the most stable phase of Al₂O₃, has a high hardness but requires a deposition temperature as high as 1000 degrees C., which is too high for coatings of electronic devices and leads to significant thermal stress. ZrO₂ requires stabilization. DLC has issues with the ability to control bonding, adhesion to substrates, and absorption in the visible range. Composite layers include TiN+SiN which is not transparent, SiO₂/resin which is a DVD coating, and Al₂O₃/SiO₂/poly which is used on wood floors. Multilayer/Superlattice materials include SiON/polymer/SiON (an OLED encapsulation) as a permeation barrier and Ti/Zr/N (on cutting tools) which is non-transparent.

However, the above mentioned approaches do not provide a housing that provides a metallic appearance, that is resistance to scratches and abrasions, and that is transmissive to radio frequency signals.

Accordingly, it is desirable to provide an electronic device housing having a metallic appearance that is resistant to scratches and abrasions and is transparent to radio frequency signals. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is an isometric view of a portable electronic device in accordance with an exemplary embodiment;

FIG. 2 is a block diagram of a portable electronic device in accordance with an exemplary embodiment;

FIG. 3 is a partial cross sectional view of a first exemplary embodiment;

FIG. 4 is a partial cross sectional view of a second exemplary embodiment;

FIG. 5 is a graph illustrating selectable colors in accordance with the exemplary embodiments;

FIG. 6 is a partial cross sectional view of a third exemplary embodiment; and

FIG. 7 is a partial cross sectional view of a fourth exemplary embodiment.

### DETAILED DESCRIPTION

The exemplary embodiments described herein include several technologies wherein incorporated metal surfaces, metal particles, or shiny particles into device structures may be actuated. The grain sizes of the particles can be adjusted to achieve the desired reflections.

Many consumers like their electronic devices to have a metallic appearance. A metallic appearance is more than just a color. Yellow-orange does not provide the look of gold, nor does gray represent stainless steel. Metals look the way they do for several reasons. First, the electronic structure of metal reflects a substantial percentage of the incident light, as much as 90%, which is much greater than most other non-metal surfaces. Typical metal surfaces are smooth enough to demonstrate significant specular reflection, rather than diffuse reflection. As a result, a metal's reflective brightness varies with the surface's angle to the light source. This gives metal its characteristic angularly-dependent brightness which varies with the relative orientations of a viewer and a light source. In addition, reflection off metal surfaces is also often polarized. Metals also have grain structures which can act of a collection of small specular reflectors with a distribution of reflecting angles. This can produce a highly reflective, but granular, texture that still maintains a large angularly dependent reflection. Some decorative metals reflect light more efficiently in the yellow and red regions of the spectrum than in the blue and green regions, providing gold and copper colors. A metallic appearance is defined as a surface exhibiting bright, predominantly specular reflections, wherein the reflections vary with the angle of the light source and are a function of the material and the granular characteristics of the surface. Metallic looking paints incorporate reflective additives, such as metal flakes and mica flakes to create the enhanced shiny look, but the paints are subject to damage, such as scratching and fading.

A coating for a housing of an electronic device is provided that includes a non-conductive, doped semiconductor layer on a substrate that is transparent to signals in the radio frequency range. The semiconductor material is doped with a metal having an atomic weight composition below 10% of the combined semiconductor material and the metal, providing a metallic appearance to visible light reflected from the doped semiconductor material. The doped semiconductor material is “hard”, therefore resistant to scratches and abrasions. Optionally, a color imparting layer may be formed over the doped semiconductor material, wherein the desired color is obtained by selecting the type of material and/or thickness of the color imparting layer. The color imparting layer provides additional scratch and abrasion resistance. The doped semiconductor layer may be patterned, and a thickness selected, to provide transparency to visible light, for example, to provide viewing of a display.

FIG. 1 shows in schematic form a mobile communication device, which may be used with the exemplary embodiments of a portable electronic device 110 described herein, and includes a display 112, a control panel 114, a speaker 116, and a microphone 118 formed within a housing 120. Conventional mobile communication devices also include, for example, other inputs which are omitted from the figure for simplicity. Circuitry (not shown) is coupled to each of the display 112, control panel 114, speaker 116, and microphone 118. It is also noted that the portable electronic device 110 may comprise a variety of form factors, for example, a “foldable” cell phone. While this embodiment is a portable mobile communication device, the present invention may be incorporated within any electronic device having elements contained within, or to be viewed through, the housing by the consumer. Other portable applications include, for example, a laptop computer, personal digital assistant (PDA), digital camera, or a music playback device (e.g., MP3 player). Non-portable applications include, for example, car radios, stainless steel refrigerators, watches, and stereo systems.

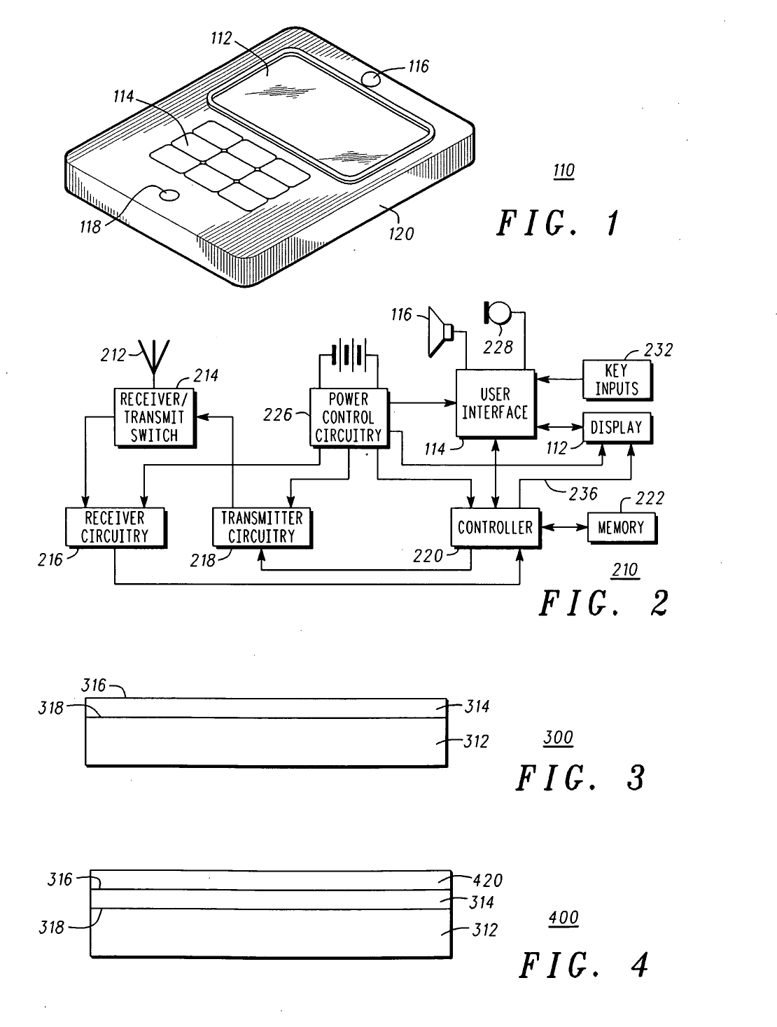

Referring to FIG. 2, a block diagram of a portable electronic device 210 such as a cellular phone, in accordance with the exemplary embodiment is depicted. Though the exemplary embodiment is a cellular phone, the invention described herein may be used with any electronic device in which information is to be presented. The portable electronic device 210 includes an antenna 212 for receiving and transmitting radio frequency (RF) signals. A receive/transmit switch 214 selectively couples the antenna 212 to receiver circuitry 216 and transmitter circuitry 218 in a manner familiar to those skilled in the art. The receiver circuitry 216 demodulates and decodes the RF signals to derive information therefrom and is coupled to a controller 220 for providing the decoded information thereto for utilization thereby in accordance with the function(s) of the portable communication device 210. The controller 220 also provides information to the transmitter circuitry 218 for encoding and modulating information into RF signals for transmission from the antenna 212. As is well-known in the art, the controller 220 is typically coupled to a memory device 222 and a user interface 114 to perform the functions of the portable electronic device 210. Power control circuitry 226 is coupled to the components of the portable communication device 210, such as the controller 220, the receiver circuitry 216, the transmitter circuitry 218 and/or the user interface 114, to provide appropriate operational voltage and current to those components. The user interface 114 includes a microphone 228, a speaker 116 and one or more key inputs 232, including a keypad. The user interface 114 may also include a display 112 which could include touch screen inputs. The display 112 is coupled to the controller 220 by the conductor 236 for selective application of voltages in some of the exemplary embodiments described below.

The exemplary embodiments described herein may be fabricated using known lithographic processes as follows. The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Though the above described lithography processes are preferred, other fabrication processes may comprise any form of lithography, for example, ink jet printing, photolithography, electron beam lithography, and imprint lithography ink jet printing. In the ink jet printing process, pigments or metal flakes may be combined in liquid form with the oil and printed in desired locations on the substrate.

Referring to FIG. 3, a first exemplary embodiment of the housing 120 is a coating 300 including a doped semiconductor material 314 formed on a substrate 312. The substrate 312 may be any rigid or flexible material; however, preferably is either glass when visible light transparency is desired or a polymer when no or little visible light transparency is desired (various exemplary embodiments will be discussed below). The semiconductor material 314 preferably is silicon that is co-deposited with a metal, preferably aluminum, wherein the metal is below 10% atomic weight composition of the doped semiconductor material. Alternatively, the semiconductor material 314 may be germanium or a compound semiconductor, and the dopant may be nickel, or other highly reflective metal such as silver. The housing 120 so constructed is non-conductive, thereby transparent to radio frequency, for example in the range of 3,000 Hertz to 300,000 GigaHertz.

The thickness of the semiconductor material 314 preferably is in the range of 50 to 500 nanometers. At the smaller dimensions, i.e., 50 nanometers, when light in the visible spectrum strikes the surface 316 of the semiconductor material 314, most will pass through the semiconductor material 314, reflecting off of the surface 318 of the substrate 312 (when a substrate non-transparent to visible light is selected). Some of the light entering the semiconductor material 314 will reflect off of the metal doped within the semiconductor material 314 and pass back through the surface 316 resulting in a metallic appearance for the coating 300. Regardless of the materials selected, and their thickness, the coating 300 is transparent to radiation in the radio frequency spectrum.

A second exemplary embodiment, shown in FIG. 4 as a coating 400, includes a color imparting layer 420 overlying the semiconductor material 314. The color imparting layer 420 preferably is either a metal oxide or metal nitride, such as Al₂O₃, Cr₂O₃, HfO₂, MgO, SiO₂, SnO₂, TiO₂, AlN, and ZrO₂. The color imparting layer 420 preferably has a thickness in the range of 50 to 500 nanometers, and imparts a color to the visible light entering therein.

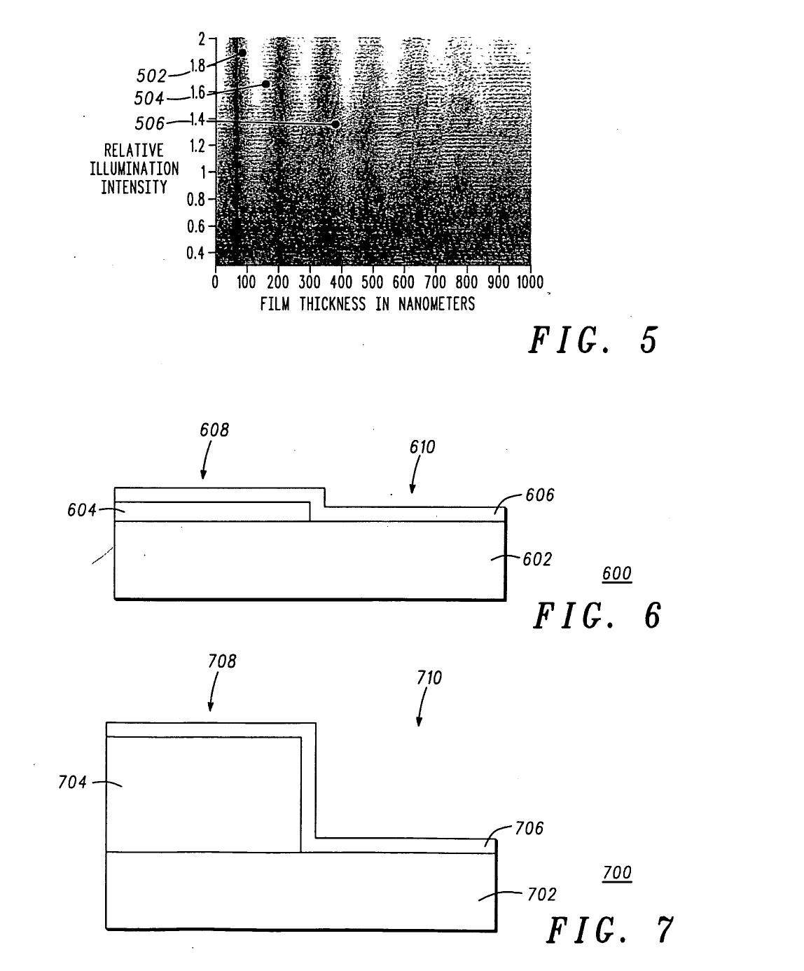

The color imparted depends on the material selected and the thickness of the color imparting layer 420. FIG. 5 illustrates the film thickness versus the relative illumination intensity for silicon nitride. A thickness of about 90 nanometers and a relative illumination intensity of about 1.9 results in a color of blue 502, a thickness of about 160 nanometers and a relative illumination intensity of about 1.65 results in a color of yellow 504, and a thickness of about 390 nanometers and a relative illumination intensity of about 1.35 results in a color of green 506. Therefore, the thickness of the color imparting layer 420 may be selected, for the specific material selected, in order to obtain a desired color.

Referring to FIG. 6, a third exemplary embodiment of a coating 600 includes a glass or polymer substrate 602 having a thickness in the range of 0.5 to 2.0 nanometers that is substantially transparent to visible light. A semiconductor material 604 doped with a metal, preferably aluminum, is formed (patterned) over a first portion 608 of the substrate 602. A color imparting layer 606 is formed over the semiconductor material 604 and a second portion 610 of the substrate 602. The thickness of the semiconductor material 604 is about 50 nanometers, resulting in the combination of the semiconductor material 604 and the color imparting layer 606 being about 50% transparent to visible light. The second portion 610 of the substrate 602, having only the color imparting layer 606 over the substrate 602, has a high transparency, for example, about 90%, to visible light. This patterning of the semiconductor material 604 allows for areas of the housing to be substantially transparent, allowing for the viewing of displays 112, for example.

FIG. 7 illustrates a fourth exemplary embodiment of a coating 700 including a polymer substrate 702 having substantially a zero transparency to visible light. A semiconductor material 704 doped with a metal, preferably silicon doped with aluminum, and having a thickness of about 500 nanometers is formed over a first portion 708 of the substrate 702. A color imparting layer 706 is formed over the semiconductor material 704 and a second portion 710 of the substrate 702. The thickness of the semiconductor material 704 results in the combination of the semiconductor material 704 and the color imparting layer 706 having a low transparency, less than 10%, to visible light. The second portion 710 of the substrate 702, having only the color imparting layer 706 over the substrate 702, has a high transparency, for example, about 90%, to visible light. This patterning of the semiconductor material 704 allows for areas of the housing to be substantially transparent, allowing for the viewing of displays 112, for example.

Each of the embodiments described herein are examples of an apparatus and method for providing a housing, or a coating for a housing, that provides a metallic appearance, and which is resistant to scratching and the like. A desired color may be selected and the coating may be patterned to provide areas transparent to visible light for viewing within the housing, for example, the viewing of a display.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A housing comprising:
a substrate; and
a semiconductor material doped with a metal overlying the substrate, the metal comprising less than a ten percent atomic weight of the combined semiconductor material and the metal, providing minimal attenuation of a radio frequency signal and visible light reflected from the semiconductor material having a metallic appearance.

2. The housing of claim 1 wherein the semiconductor material comprises a thickness above the substrate of 50 to 500 nanometers.

3. The housing of claim 1 wherein the housing contains an electronic device including an antenna conducting a radio frequency signal.

4. The housing of claim 1 wherein the semiconductor material comprises a pattern formed over the substrate.

5. The housing of claim 1 further comprising a color imparting layer over the semiconductor material, wherein a thickness of the color imparting layer determines a color of light in the visual spectrum reflected therefrom.

6. The housing of claim 6 wherein the color imparting layer comprises a thickness above the semiconductor material of 50 to 500 nanometers.

7. The housing of claim 6 wherein the semiconductor material is patterned over a first portion of the substrate, and the color imparting layer is also formed over a second portion of the substrate.

8. An electronic device, comprising:
circuitry;
an antenna coupled to the circuitry for conducting signals in the radio frequency range;
a housing encasing the circuitry and the antenna, the housing comprising:
a substrate;
a coating material overlying the substrate and comprising a material being substantially non-conducting and including a metal, the metal comprising below a ten percent atomic weight of the combined non-conducting material and the metal, the housing minimally attenuating signals in the radio frequency range and giving a metallic appearance to reflected light in the visible range.

9. The electronic device of claim 8 wherein the housing further comprises a visual and RF transparent layer formed over the coating material and having a thickness to provide a desired color, surface hardness, and scratch resistance.

10. The electronic device of claim 8 wherein the non-conducting material comprises a thickness above the substrate of 50 to 500 nanometers.

11. The electronic device of claim 8 wherein the non-conducting material comprises a pattern formed over the substrate.

12. The electronic device of claim 8 further comprising a color imparting layer over the semiconductor material, wherein a thickness of the color imparting layer determines a color of light in the visual spectrum reflected therefrom.

13. The electronic device of claim 12 wherein the color imparting layer comprises a thickness above the semiconductor material of 50 to 500 nanometers.

14. The electronic device of claim 12 wherein the semiconductor material is patterned over a first portion of the substrate, and the color imparting layer is also formed over a second portion of the substrate.

15. A method of forming a housing for an electronic device including a radio frequency antenna, the method comprising:
forming a semiconductor material doped with a metal which comprises less than ten percent atomic weight of the combined semiconductor material and the metal, wherein the semiconductor material is transparent to radio frequency signals and gives a metallic appearance to visible light reflected therefrom.

16. The method of claim 15 wherein the forming step comprises forming the semiconductor material having a thickness above the substrate of 50 to 500 nanometers.

17. The method of claim 15 wherein the forming step comprises patterning the semiconductor material.

18. The method of claim 15 further comprising forming a color imparting layer over the semiconductor material, wherein a thickness of the color imparting layer determines a color of light in the visual spectrum reflected therefrom.

19. The method of claim 18 wherein the forming a color imparting layer step comprises forming the color imparting layer having a thickness above the semiconductor material of 50 to 500 nanometers.

20. The method of claim 18 further comprising patterning the semiconductor material over a first portion of the substrate, and the forming a color imparting layer step comprises forming the color imparting layer over a second portion of the substrate.

21. The method of claim 15 further comprising forming a color imparting layer over the semiconductor material, wherein the material of the color imparting layer determines a color of light in the visual spectrum reflected therefrom.
